(19) United States
(12) Patent Application Publication
(10) Pub. No.: US 2011/0153384 A1
(43) Pub. Date: Jun. 23, 2011

(54) Visual comps builder

(76) Inventors: Matthew Donald Horne, Coatesville, PA (US); Catherine Hollenbeck Martin, New York, NY (US); Dean Anthony Oligino, Westfield, NJ (US)

(21) Appl. No.: 12/653,720

(22) Filed: Dec. 17, 2009

(51) Int. Cl. G06Q 10/00; G06F 17/30; G06F 12/00; G06Q 40/00

(52) U.S. Cl. 705/7.29; 707/769; 711/118; 707/706; 707/E17.108; 711/E12.001

(57) ABSTRACT

A user enters search criteria for comparable transactions into a computer system and the computer system generates a scatter plot of deals meeting the search criteria from a transaction database. A computer cache, data tray, or “shopping cart” can be used to save relevant deals which then can be automatically incorporated into an electronically generated comps report.

### TECHNICAL FIELD

This disclosure relates to computer technology useful in evaluating business, investment, and financial transactions, such as mergers and acquisitions transactions. More specifically, this disclosure relates to computer technology that generates information about comparable prior transactions useful to those involved in evaluating proposed new transactions.

### BACKGROUND

People involved in business, investment, and financial transactions, such as businessmen, investment bankers, lawyers, financial advisors and consultants, and others working in the field of mergers and acquisitions transactions, need a way to accurately and quickly evaluate the transactions on which they are working. For any given transaction, they need to be able to accurately value the transaction in terms of how much to pay (e.g., whether the payment constitutes a percent premium) and how to pay (e.g., is it advisable to use stock, debt, cash, or some other payment vehicle to make the acquisition). This is usually done by analyzing similar transactions that closed in the past and comparing the characteristics of those past transactions with the proposed transaction being evaluated. Transactions that are similar to the transaction being evaluated, known as comparables or comps, can be used as a guide to evaluate or set the terms of the transaction being evaluated.

Previously, computer systems were used to search a computer database containing information about past transactions. The search results were then manually reviewed and researched one at a time to find the comparables. New searches were made until a sufficient number of useable deals were obtained (i.e., enough comparables had been found that could be used to justify certain numbers). As the comparables were identified, they were manually inserted into reports such as those created with spreadsheet or presentation software. This is a manual, tedious process which needs to be streamlined.

### SUMMARY

The solution to the problems in generating comparables in the mergers and acquisitions area and other financial, investment, and business transactions is to have a computer system in which the user enters search criteria and the computer generates a scatter plot of deals meeting the search criteria from a transaction database. A computer cache, data tray, or “shopping cart” can be used to save relevant deals which then can be automatically incorporated into an electronically generated report.

In one embodiment of the invention, an appropriately programmed computer evaluates a proposed mergers and acquisitions transaction by generating comparables information for the proposed transaction from a mergers and acquisition database. The method involves entering a first set of one or more search criteria into a computer, the search criteria representing one or more characteristics of a completed mergers and acquisition transaction. A transactions data base containing data representing a set of completed mergers and acquisitions transactions is searched to identify a first set of one or more transactions in the data base meeting the search criteria. A multidimensional scatter plot of the first set of identified transactions is displayed on a computer display. A selected subset of the first set of transactions representing potentially comparable transactions may be stored in a data cache for later examination and analysis. Further searching may be performed using different search criteria and further transactions returned by the additional searching may be added to the cache. The contents of the cache may be entered into an electronically generated comparables report or displayed in a scatter plot for further analysis.

### BRIEF DESCRIPTION OF THE DRAWINGS

FIG. 1 is schematic diagram of an example of a computer system that implements one embodiment of the invention of this application.

FIG. 2 is a screen shot from the display of FIG. 1 illustrating an example of a scatter plot produced in accordance with one example of the invention.

FIG. 3 is another screen shot from the display of FIG. 1 illustrating a filtered subset of the data in the scatter plot of FIG. 2.

FIG. 4 is an additional screen shot from the display of FIG. 1 illustrating the selection of one of the transactions to be added to a shopping cart or data cache in accordance with one example of the invention.

FIG. 5 is another screen shot that illustrates the graphical user interface after the addition of the selected transaction to the data cache or shopping cart.

FIG. 6 is a screen shot of a scatter plot of the contents of the shopping cart after a number of comparable transactions have been stored therein.

FIG. 7 is a screen shot showing illustrative summary of the filter settings that produce a typical scatter plot.

### DETAILED DESCRIPTION

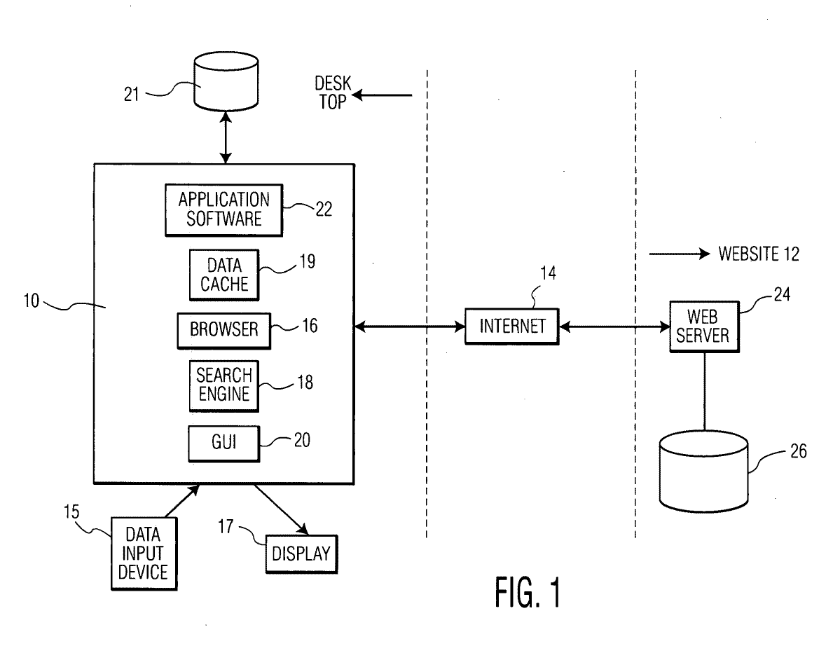

FIG. 1 shows an illustrative computer architecture in accordance with one implementation of the invention. The architecture of FIG. 1 comprises a computer 10 configured for access to a mergers and acquisitions web site 12 through the Internet 14. The computer 10 may be a stored program computer containing the usual central processing unit (CPU), random access memory, read only memory, and hard drive or other non-volatile storage device. The computer 10 is connected to a local mergers and acquisition transaction database 21 which may be located on the aforementioned hard drive. The local transaction data base 21 contains the information about prior transactions downloaded from the web site 12 in this example of the invention. The computer 10 also includes one or more data input devices 15, such as a mouse, a touch screen, and/or a keyboard, for entering search criteria and other information into the computer 10. The computer 10 also has network interface circuitry needed to access the Internet 14.

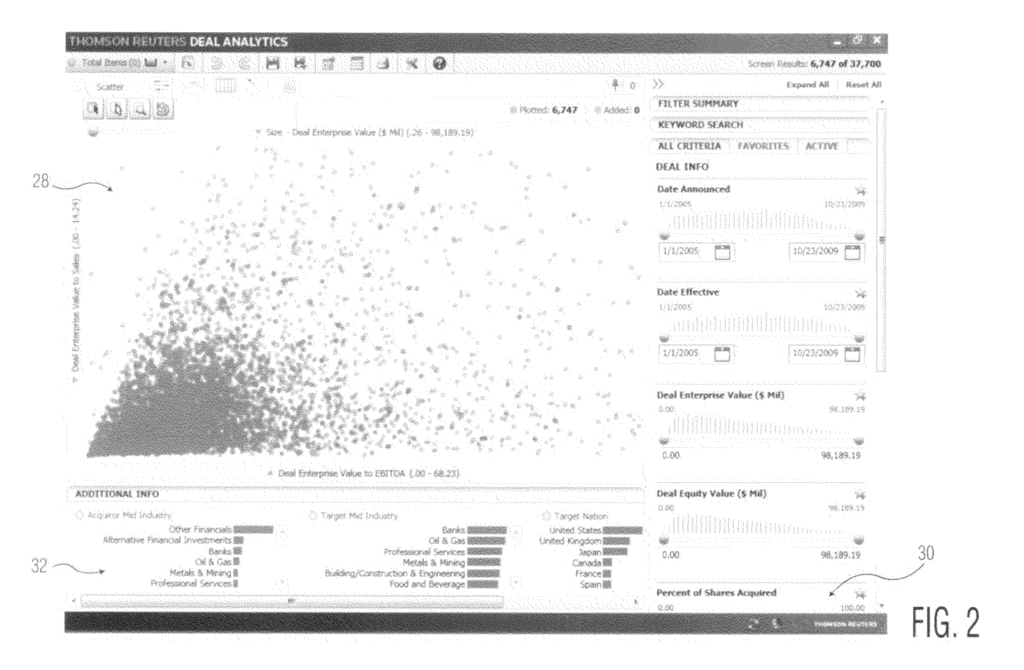

The computer also contains a browser 16 that is used to access selected web sites on the Internet 14, such as web site 12 in FIG. 1. A search engine 18 allows the computer 10 to search the Internet 14 and other devices contained in or connected to the computer 10, such as the local database 21. A graphical user interface 20 in the computer 10 is connected with the computer display 17 to display the visual features described in connection the description of the screen shots in FIGS. 2-7 below. Application software 22 in the computer 10 may include spread sheet software, such as Microsoft Excel, and presentation software, such as Microsoft PowerPoint, that are useful in preparing reports of comparable transactions.

Application software 22 also includes transaction evaluation software that comprises a set of instructions invoked by a user and executed by the computer 10 to build a set of comparable transactions that can be displayed as a multidimensional scatter plot and stored in a shopping cart-like data cache. The comparable transactions are useful in evaluating a proposed mergers and acquisition transaction in accordance with one example of the invention. More specifically, the comparable transactions may be transactions that were consummated in the past that have characteristics similar to those of a transaction being evaluated. The characteristics of the comparables can be used as evidence to assess the appropriateness of the terms of the transaction under consideration, such as whether the purchase price is appropriate. The detailed operation of the evaluation software in the application software 22 will be apparent to those skilled in the art from the discussion of FIGS. 2-7 below. The evaluation software may be supplied to the computer 10 in any manner, for example, by way of any suitable computer readable medium, for example, a CD, DVD, or flash drive. The computer readable medium contains instructions that are executable by the computer to search a transaction database to build a set of comparable transactions, to display those transactions in a multidimensional scatter plot, and to store those transactions in a data cache in accordance with the principles of this invention.

The computer 10 may be a personal computer, such as a desktop PC, a laptop computer, or a net book computer. It may also be a workstation, or other kind of computer, a personal digital assistant, mobile telephone, or other handheld device, or any other device capable of searching a transactions database like databases 21 or 26, displaying the search results in the form of a multidimensional scatter plot like the ones shown in FIGS. 2-7, and providing the capability of storing the search results in a data cache or shopping cart. Transaction database 21 may be located in the computer 10 or may be outside the computer 10. Access to transaction databases outside the computer 10 can be provided via a wired or wireless communication link, the computer 10 and the transaction database being either directly connected together or through a network such as a local-, wide area-, private-, or virtual-private network.

The web site 12 comprises a web server 24 which provides information about completed mergers and acquisitions transactions, a subset of which will be identified a set of comparables related to a potential transaction being evaluated by a user of the computer system of FIG. 1. The information about prior transactions is stored in a host mergers and acquisition transaction data base 26. That information may include a variety of financial and business data about the parties and the transaction, such as the date of the transaction, earnings and sales data relating to the acquiring and target companies, how much the acquiring company paid for the target company, how the purchase price was paid, and any other business or financial data pertinent to the valuation of a mergers and acquisitions transaction, such as the acquisition of one company by another company.

In one example of the invention involving valuation of a mergers and acquisitions transaction, for example, a transaction involving the sale of a target company to an acquiring company, a user of the computer 10 can request that the entirety of the mergers and acquisition data in the transaction data base 26 be downloaded from the web site 12 to the computer 10 and stored in the local transaction data base 21, where it can be searched for comparable transactions by using the search engine 18 in the computer 10. In another embodiment of the invention, the transaction information in the transaction database 26 can be searched without downloading it to the computer 10. Those skilled in the art will realize that there are other methods of storing the transaction information and supplying it to a user for searching, for example, a CD-ROM loaded into the computer 10.

In order to evaluate a mergers and acquisition transaction, the computer system of FIG. 1 is used identify the comparables for that transaction. In this example of the invention, the universe of transactions in database 26 that might be comparables have been downloaded from the database 26 to data base 21. A user of computer 10 first enters one or more search criteria into the computer 10 through the data input device 15. The search criteria represent one or more characteristics of completed mergers and acquisition transactions, namely, one or more of the pieces of data in the database 26 that have been copied into database 21, that are associated with respective transactions stored in the databases 21 and 26. The transactions database 21 then is searched by the search engine 18 to identify a first set of one or more transactions in the data base 21 meeting the search criteria. A multidimensional scatter plot 28 shown in FIG. 2 of the first set of identified transactions is displayed by the graphical user interface 20 on the computer display 17.

FIG. 2 is a screen shot that illustrates what the graphical user interface 20 displays to a user as a result of a search of the local transactions database 21. The screen shot of FIG. 2 shows the aforementioned multidimensional scatter plot 28 which depicts each transaction satisfying the search criteria as a data point on a two dimensional Cartesian coordinate plane. In this example of the invention, the Cartesian coordinate plane is a representation of (a) the ratio of the deal enterprise value to the earnings of the target company before interest, taxes, depreciation, and amortization (EBITDA) on the x-axis versus (b) the ratio of the deal enterprise value to the sales of the target company on the y-axis. Search criteria in this example of the invention may be a range of values of the parameters (a) and (b) above. They can be set by manipulating a filter pane 30 shown in FIG. 2. The filter pane 30 comprises a list of search criteria extending vertically along the right hand edge of the screen shot of FIG. 2. One or more of the search criteria is associated with a slider underneath each search criterion that can be manipulated back and forth by performing a drag or point operation with a mouse that is part of the data input device 15 in FIG. 1. Manipulation of the sliders sets the range of the criteria that will be used in the search. For example, manipulation of the sliders may define a search of the data base 21 for transactions involving target companies sized between defined upper and lower bounds. The list of search criteria may include the parameters (a) and (b) above, and any other relevant business or financial parameters associated with the transactions in the database 21. The search engine 18 identifies the transactions in the database 21 that have parameters (a) and (b) that fall within the specified ranges and creates a scatter plot by placing a circular dot in the appropriate places on the Cartesian coordinate plane of FIG. 2. In some embodiments, the size, shape, or color of the dots may also indicate additional characteristics of the respective transaction, for example, the size of each dot may indicate the size of the transaction associated with the dot. Those skilled in the art will appreciate that there are other multimedia indicators or differentiators that may be associated or linked with each dot to provide information beyond the two dimensional information provided by a dot's position on the Cartesian coordinate plane. For example, placing the computer's cursor on a dot of interest may open a window with additional information about the transaction associated with that dot.

Statistical information about the scatter plot may be displayed in a statistics pane 32 at the bottom of the screen shot of FIG. 2. In the example of the invention shown in FIG. 2, bar graphs indicating the number of acquiring companies in the scatter plot that are in certain industries appear in the left hand column of the statistics pane 32. The middle column of the statistics pane 32 shows how many target companies in the scatter plot are in certain industries. The right hand column in the statistics pane 32 indicates how many transactions in the scatter plot were in certain indicated countries.

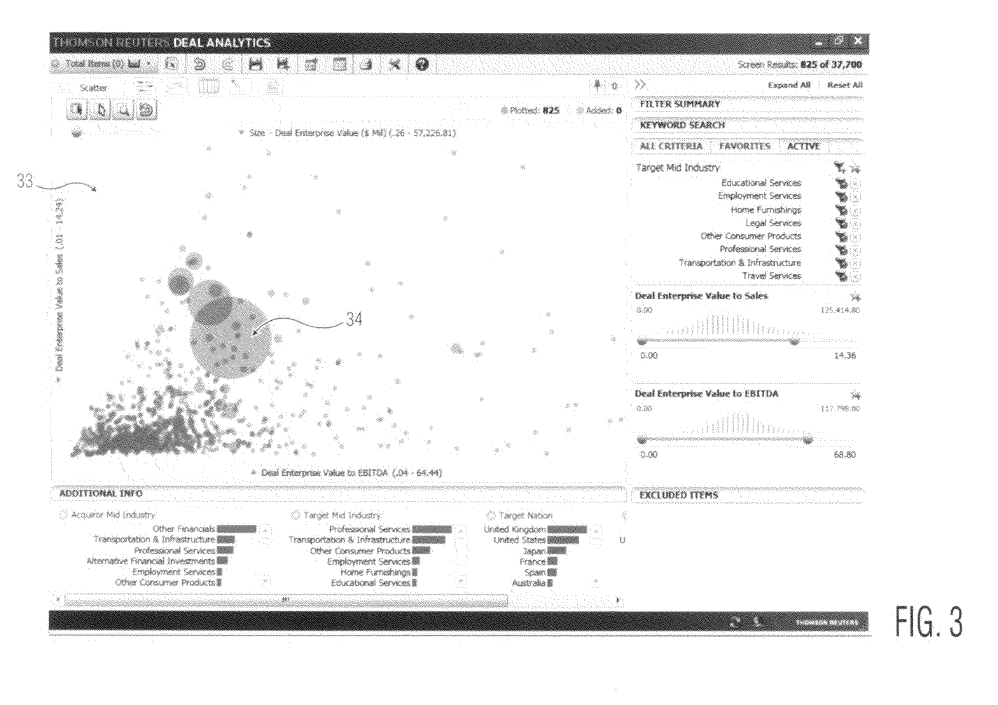

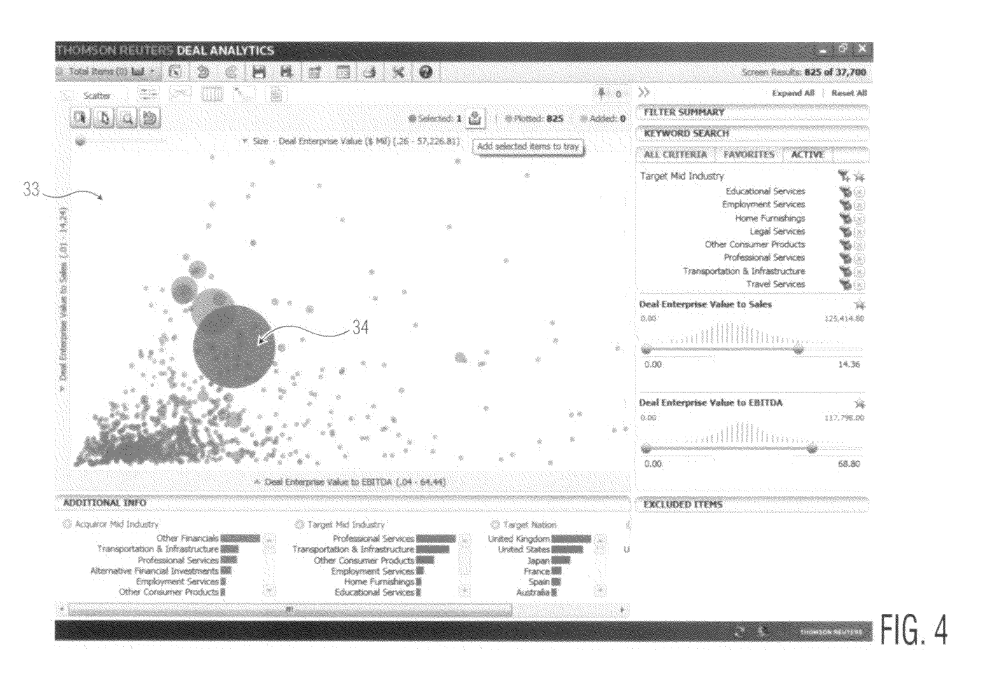

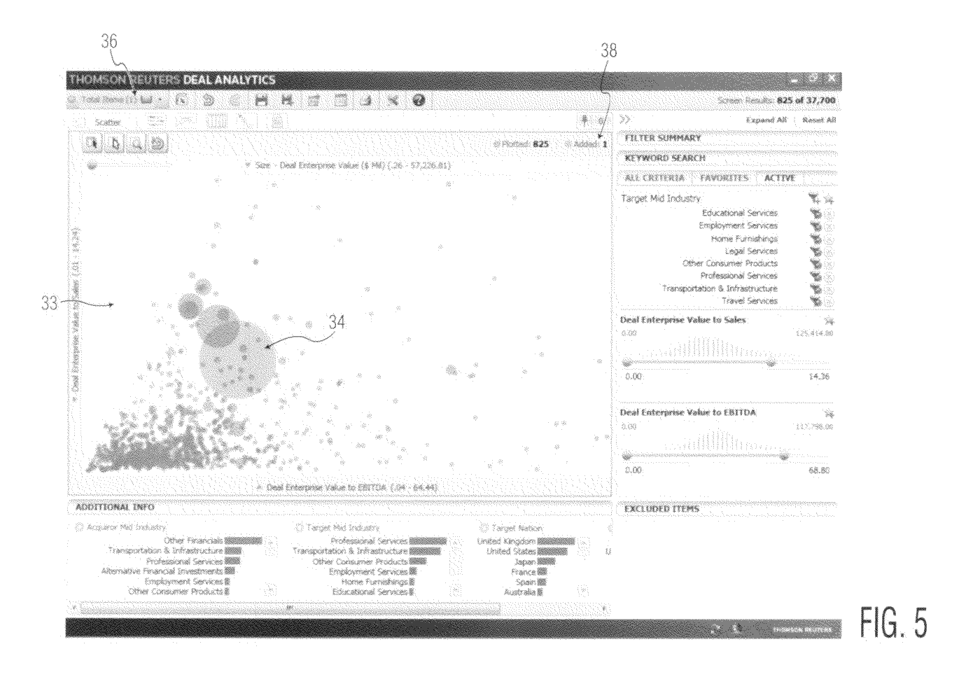

The scatter plot of FIG. 2 may be filtered by refining the search that produced the scatter plot. The search may be refined by narrowing the search criteria or applying new search criteria to the data in the scatter plot. The screen shot of FIG. 3 shows the result of filtering the data of FIG. 2. FIG. 3 shows a scatter plot 33 which is a subset of the data in the scatter plot 28 of FIG. 2 reflecting restricted search criteria. In this example of the invention, the sizes of the dots representing each transaction vary in accordance with the size of the transaction they represent, in this case the deal enterprise value. See, for example, the large dot 34 that represents a transaction involving the purchase of a relatively large company, as indicated by the relatively large size of the dot 34. The transaction represented by the dot 34 in FIG. 3 may be selected by way of data input device 15, such as by clicking on the dot 34, typing the selection on a keyboard, or contacting a touch screen. Some indication is sent to the display 17 by the graphical user interface 20 that the transaction 32 has been selected, for example, by changing the color or shading of the dot 34, as shown in FIG. 4. The data associated with dot 34 may then be stored in a data cache, shopping cart, or data tray for further use later. In FIG. 5, the transaction associated with dot 34 has been entered into the data cache 19 in computer 10. A count of the number of transactions in the data cache 19 is shown in the upper left hand corner of the screen shot of FIG. 5 at reference numeral 36 and also in the upper right hand corner of that Figure at reference numeral 38. A comparison of the screen shots of FIGS. 4 and 5 will reveal that the count of transactions in the data cache has been incremented by one as a result of placing the transaction associated with dot 34 in the data cache 19.

Additional transactions from the filtered set of transactions in the scatter plot of FIG. 3 may be identified and placed in the data cache 19. Additional searches of the transaction database 21 using new search criteria and additional filtering of the results may be made, and new additions to the data cache 19 may be made until a desired number of comparables have been found. The number and nature of the searches and filtrations are not critical as long as a sufficient number of comparable transactions have been identified to provide a confidence level that the numbers of the transaction being analyzed are justified.

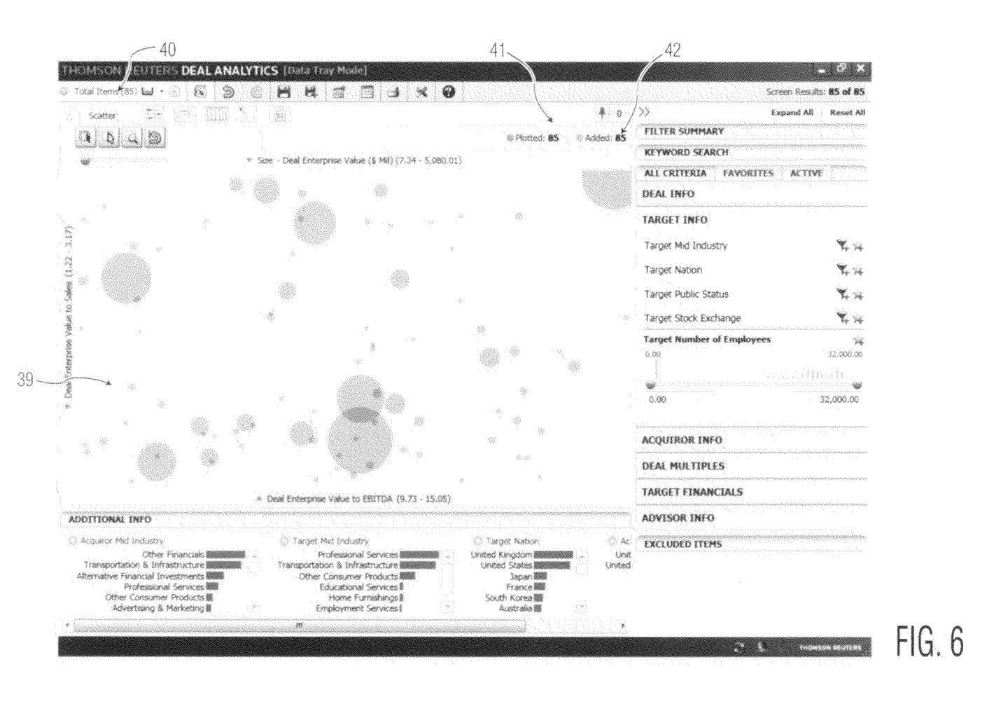

The transactions in the data cache 19 may be displayed as a scatter plot as shown in FIG. 6 by clicking on an appropriate button on the computer display which invokes a display of the scatter plot 39 in FIG. 6. As is apparent from reference numerals 40, 41 and 42 in FIG. 6, an illustrative number of 85 transactions reside in the data cache 19 and are plotted on the scatter plot 39. In addition to being displayed on a scatter plot, the data in the data cache 19 may also be processed by the application software 22 in the computer 10 to prepare spread sheets and presentations, such as Microsoft Excel spreadsheets and Microsoft PowerPoint presentations.

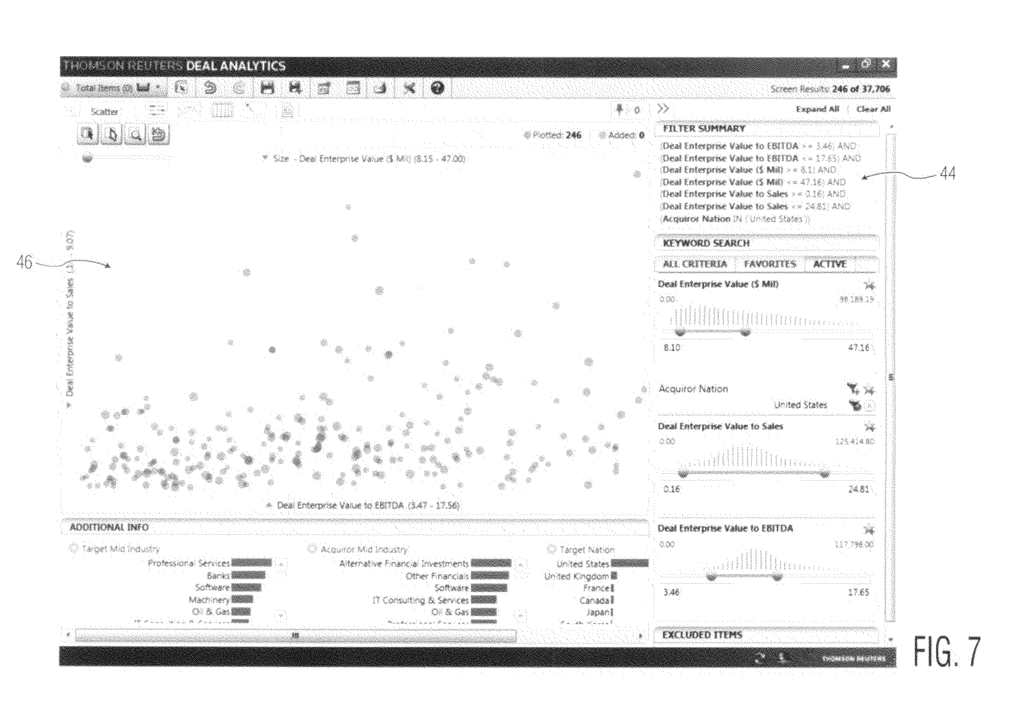

The computer 10 in accordance with this example of the invention keeps track of all of the filter parameters that have been applied to the data returned by a search and displayed as a scatter plot. FIG. 7 illustrates a screen shot which illustrates a running tab 44 of all the filters that have been applied to the data in a scatter plot 46.

Although a specific example of the invention is described above, involving evaluation of a mergers and acquisition transaction, more particularly, involving evaluation of an acquisition of one company by another company, the principles of the invention are also applicable to analysis of other financial, investment, and business transactions. These transactions may be new equity offerings, such as initial public offerings (IPO's) and secondary equity offerings (SEO's). Fixed income offerings, such as bonds, money markets, CDO's, and CMO's, are also able to be analyzed in accordance with the principles of the invention. Options, mutual fund composition and performance, equity ownership activity (buying and selling by holders), private equity investments and performance, and analyst estimates, recommendations and rankings, league table rankings, and company fundamental, estimate and ratio data may also be analyzed in accordance with the invention.

1. A computer implemented method of evaluating a transaction by generating comparables information for the transaction, comprising the steps of
(a) entering a first set of one or more search criteria into a computer, the search criteria representing one or more characteristics of other transactions;
(b) searching a transactions data base containing data representing other transactions to identify a first set of one or more transactions in the data base meeting the search criteria; and
(c) displaying a multidimensional scatter plot of the first set of identified transactions on a computer display.

2. The method of claim 1, further comprising the step of:
storing one or more of the identified transactions in a data cache as transactions comparable to the transaction being evaluated.

3. The method of claim 1, in which the transactions are mergers and acquisition transactions.

4. The method of claim 1, in which the transactions are acquisitions of one company by another company.

5. The method of claim 3, further comprising the step of:
storing one or more of the identified transactions in a data cache as transactions comparable to a proposed mergers and acquisition transaction.

6. The method of claim 5, further comprising the steps of:
(a) entering a second set of one or more search criteria into the computer, the search criteria representing a second set of one or more characteristics of completed mergers and acquisition transactions;
(b) searching the transactions data base to identify a second set of one or more transactions in the data base meeting the second set of search criteria; and
(c) displaying a multidimensional scatter plot of the second set of identified transactions on a computer display.

7. The method of claim 6, further comprising the step of:
storing one or more of the second set of identified transactions in the data cache as transactions comparable to the proposed mergers and acquisition transaction.

8. The method of claim 3, further comprising the step of filtering the first set of one or more transactions in accordance with one or more filter criteria to derive a subset of the first set of transactions.

9. The method of claim 8, further comprising the step of:
storing one or more of the subset of identified transactions in the data cache as transactions comparable to the proposed mergers and acquisition transaction.

10. The method of claim 9, further comprising the step of:
the computer generating a report of the transactions stored in the cache.

11. The method of claim 1, further comprising the step of:
the computer generating a graphical user interface on a computer display adapted to receive and display the information in the scatter plot.

12. The method of claim 3, in which the database stores data representing one or more transaction characteristics associated with one or more of the transactions in the database.

13. The method of claim 12, in which the transaction characteristics includes sales data and earnings data for a company involved in a completed transaction in the database.

14. The method of claim 3, in which the scatter plot is a two dimensional representation of the sales of a target company versus the earnings of the target company for the first set of transactions.

15. The method of claim 3, in which the scatter plot is a two dimensional representation, for each of the transactions in the first set of transactions, of:
(a) a ratio of a deal enterprise value of a respective transaction to the sales of a respective target company versus
(b) a ratio of the deal enterprise value to the earnings of the respective target company.

16. The method of claim 14, in which the scatter plot is a two dimensional representation of the sales of a target company versus the earnings before interest, taxes, depreciation, and amortization of the target company for the first set of transactions.

17. The method of claim 1, in which the transactions are selected from the group consisting of:
mergers and acquisitions transactions;
equity offerings;
fixed income offerings;
options;
mutual fund composition and performance;
equity ownership activity;
private equity investments and performance;
analyst estimates, recommendations and rankings;
league table rankings; and
company fundamental, estimate and ratio data.

18. A computer system adapted to generate comparables data for a transaction, comprising:
a computer;
a data entry device adapted to receive from a user, and to enter into the computer, a set of search criteria, the search criteria representing one or more characteristics of another transaction;
a computer display adapted to display information from the computer;
a graphical user interface in the computer adapted to control the display of information on the computer display;
a search engine adapted to search a transactions data base containing data representing a set of transactions to identify a set of one or more transactions in the data base meeting the search criteria; and
evaluation software in the computer adapted to control the graphical user interface to display on the computer display a multidimensional scatter plot of the first set of identified transactions on the computer display.

19. The computer system of claim 18, further comprising:
a data cache adapted to receive and store data relating to one or more of the transactions returned by a search of the transactions database.

20. A computer readable medium storing computer executable instructions that when executed by the computer, searches a transaction database to build a set of comparable transactions, displays those comparable transactions in a multidimensional scatter plot, and stores selected ones of those transactions in a data cache.
